(19) United States
(12) Patent Application Publication
(10) Pub. No.: US 2001/0018306 A1
(43) Pub. Date: Aug. 30, 2001

(54) Vacuum formed coated fibrous mat and laminate structures made therefrom

(76) Inventors: Damon Lee Jones, Terre Haute, IN (US); Carl Douglas Ray, Terre Haute, IN (US)

Correspondence Address: JENKENS & GILCHRIST, PC, 1445 ROSS AVENUE, SUITE 3200, DALLAS, TX, 75202, US

(21) Appl. No.: 09/788,901

(22) Filed: Feb. 19, 2001

Related U.S. Application Data
(63) Continuation-in-part of application No. 09/274,069, filed on Mar. 22, 1999, now Pat. No. 6,211,102.

(51) Int. Cl. B32B 3/00; B32B 5/02; B32B 9/00

(52) U.S. Cl. 442/149; 442/59; 442/150

(57) ABSTRACT

A composite structure having a fibrous mat with perforated film coverings vacuumed formed on both sides of the fibrous mat. The composite structure is affixed between a structural foam and a soft foam to create a component part for use in applications such as automotive trim parts.

### BACKGROUND OF THE INVENTION

1. Field of the Invention

The present invention generally relates to mats of fibrous materials, and in particular to laminates of fibrous mats with perforated film coverings.

2. History of Related Art

Fibrous mats are used in various applications such as in the construction of automotive trim parts. Prior art technology formed the fibrous mats for automotive trim by spraying adhesives onto chopped fiberglass roving. The adhesive bonds the fiberglass together and to substrates. Different layers of fiberglass, foams, adhesives, and other materials were subsequently stacked together by hand to construct a sandwich, which is then formed into a biscuit and used for the production of the finished trim part.

However, the use of the prior art fibrous mats required many steps and excessive labor to produce the biscuit for use in the automotive trim parts. Therefore, there is a need for fibrous mats that can be used for the formation of multiple layer structure with fewer steps and less labor. Additionally, there is need for a fibrous mat for use in forming a multiple layer structure that has a lower weight, good thermoformability, good acoustical properties, and improved stiffness.

### SUMMARY OF THE INVENTION

In one embodiment, the present invention is a composite structure generally including a fibrous mat, a first film covering, and a second film covering. The fibrous mat has a mat first side and a mat second side, and is formed from a plurality of fibers such that a plurality of passages are formed therein. The first film covering is disposed on the mat first side of the fibrous mat, and has a plurality of first film protrusions with first film apertures that extend into the plurality of passages in said fibrous mat. The second film covering is disposed on the mat second side of said fibrous mat and has a plurality of second film protrusions with second film apertures that extend into the plurality of passages in said fibrous mat.

In another embodiment, the present invention is a composite structure including a fibrous mat having a mat first side and a mat second side, and an adhesive film covering disposed on the mat first side of said fibrous mat. The fibrous mat is formed from a plurality of fibers such that a plurality of passages are formed therein. The adhesive film covering has a plurality of adhesive film protrusions with adhesive film apertures that extend into the plurality of passages in the fibrous mat.

In yet another embodiment, the present invention is a composite structure including a fibrous mat having a mat first side and a mat second side, and a multi layer film covering disposed on the mat first side of said fibrous mat. The fibrous mat is formed from a plurality of fibers such that a plurality of passages are formed therein. The multi layer film covering includes a plurality of multi layer film protrusions with multi layer film apertures, the plurality of multi layer film protrusions extending into the plurality of passages in said fibrous mat.

In yet another embodiment, the present invention is a process for forming a composite structure including the steps of providing a fibrous mat having a mat first side and a mat second side; placing the mat second side of the fibrous mat on a first perforated screen; disposing a first film covering material on the first side of the fibrous mat disposed on the first perforated screen; applying a vacuum to the back side of the first perforated screen with the fibrous mat and first film covering material disposed thereon to form a first film covering on the first side of the fibrous mat; placing the fibrous mat onto a second perforated screen with the first film covering adjacent to the second perforated screen; and, disposing a second film covering material onto the second side of the fibrous mat disposed on the second perforated screen; applying a vacuum to the back side of the second perforated screen with the first film covering, the fibrous mat, and the second film covering material disposed thereon to form a second film covering on the second side of the fibrous mat.

In yet another embodiment, the present invention is a process for forming a composite structure including the steps of providing a fibrous mat having a mat first side and a mat second side; placing the mat second side of the fibrous mat on a first perforated screen; coextruding a multiple layer first film covering material on the first side of the fibrous mat disposed on the first perforated screen; and, applying a vacuum to the back side of the first perforated screen with the fibrous mat and first film covering material disposed thereon to form a first film multiple layer covering on the first side of the fibrous mat.

In yet another embodiment, the present invention is a composite part including a composite mat structure and a foam layer. The composite mat structure includes a fibrous mat having a mat first side and a mat second side, a first film covering disposed on the mat first side of said fibrous mat, a second film covering disposed on the mat second side of said fibrous mat. The fibrous mat of the composite mat structure is formed from a plurality of fibers such that a plurality of passages are formed therein. The first film covering of the composite mat structure has a plurality of first film protrusions with first film apertures, the plurality of first film protrusions extending into the plurality of passages in the fibrous mat. The second film covering of the composite film structure includes a plurality of second film protrusions with second film apertures, the plurality of second film protrusions extending into the plurality of passages in the fibrous mat. The foam layer adheres to the first film covering of said composite mat structure. In a further embodiment, the present invention the first film covering is a multi layer film having a first external adhesive layer adjacent to said first foam layer. In another further embodiment, the present invention includes a second foam layer adhered to the second film covering of the composite mat structure. In yet a further embodiment, the second film covering is a multi layer film having an second external adhesive layer adjacent to the second foam layer.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an enlarged partial cross section of a laminate illustrating an embodiment of the present invention FIG. 2 is an enlarged partial perspective view of the laminate from FIG. 1;

FIG. 3 is an enlarged partial cross section of another embodiment of the laminate from FIG. 1;

FIG. 4 is an enlarged partial cross section of yet another embodiment of the laminate from FIG. 1;

FIG. 5 is a schematic view of one embodiment of a process for forming the laminate of the present invention;

FIG. 6 is a more detailed schematic of the first film covering forming station from the process in FIG. 5;

FIG. 7 is a more detailed schematic of the second film covering forming station from the process in FIG. 5;

FIG. 8 is a partial perspective view of a component part made according to the present invention with the composite structure from FIG. 4;

FIG. 9 is an enlarged partial cross section of the two layer coated fibrous mat and foam board laminate constructed in accordance with the present invention;

FIG. 10 is an enlarged partial cross section of the three layer laminate with a foam board core;

FIG. 11 is an enlarged partial cross section of the three layer laminate with a coated fibrous mat core;

FIG. 12 is a schematic view of one embodiment of a process for forming the laminate of the present invention by continuous fusion lamination;

FIG. 13 is a schematic view of one embodiment of an alternative process for forming the laminate of the present invention implementing a forming press; and

FIG. 14 is a schematic view of one embodiment of a process for forming an in situ foam core laminate of the present invention.

### DETAILED DESCRIPTION

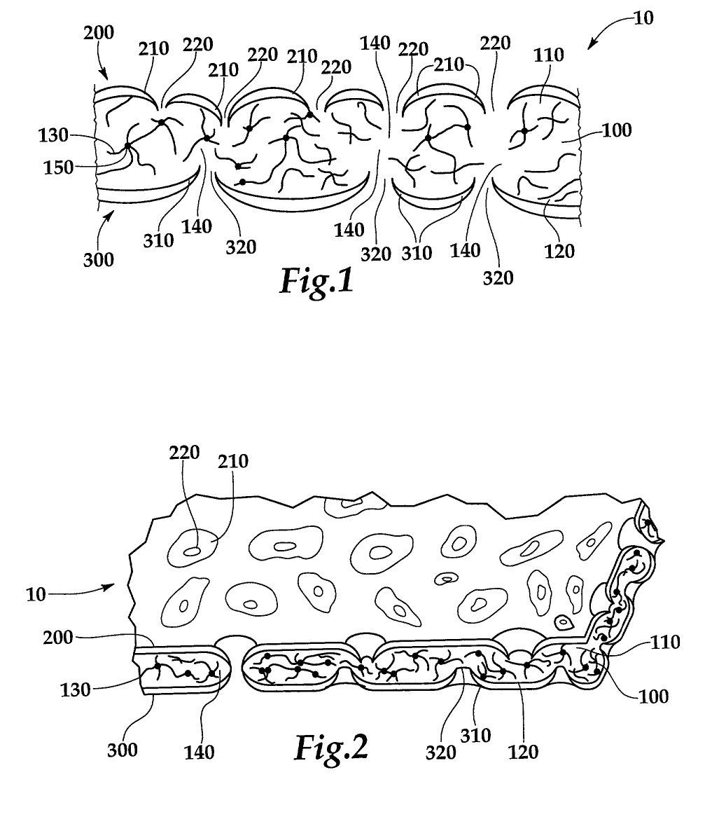

Referring now to the figures, and in particular to FIGS. 1-4, there is disclosed an embodiment of the present invention illustrated as the composite structure 10. The composite structure 10 generally comprises a fibrous mat 100 with a mat first side 110 and a mat second side 120, a first film covering 200 disposed on the mat first side 110, and a second film covering 300 disposed on the mat second side 120. The first film covering 200 includes first film protrusions 210 extending into the fibrous mat 100 and first film perforations 220. The second film covering 300 includes second film protrusions 310 extending into the fibrous mat 100 and second film perforations 320.

The fibrous mat 100 is formed of a plurality of synthetic or natural fibers 130 such as fiberglass, sisal, polymeric fibers, excelsior, combinations thereof, or the like. The fibers 130 in the fibrous mat 100 are arranged such that mat openings/passages 140 are formed in the fibrous mat 100. The mat opening/passages 140 in the fibrous mat 100 provide an open area in the fibrous mat 100 between the mat first side 110 and mat second side 120. In one embodiment, the fibrous mat 100 includes a binder 150 that holds together the fibers 130 in the fibrous mat 100.

The characteristics of the fibrous mat 100, such as stiffness, thickness, and/or open area, are selected based upon the contribution of the fibrous mat 100 to the criteria of the composite structure 10, such as stiffness and sound deadening. In one preferred embodiment, the fibrous mat 100 has a thickness of from about 10 mils to about 25 mils and an open area of from about 10% to about 50% open area. The parameters of the components of the fibrous mat 100, such as the fibers 130 and the binder 150, determine the characteristics of the fibrous mat 100. For example, the density, diameter, size, and modulus of elasticity of the fibers 130 will contribute to the stiffness and open area properties of the fibrous mat 100. The binder 150 will also contribute to the stiffness and open area of the fibrous mat 100. The first film covering 200 adheres to the fibers 130 exposed on the mat first side 110 of the fibrous mat 100. In a preferred embodiment, the first film covering 200 encapsulates some of the fibers 130 on the mat first side 110. The first film protuberances 210 extend through the mat first side 110 into the mat opening/passages 140 of the fibrous mat 100. The first film perforations 220 are formed at the end of the first film protuberances 210.

Similar to the first film covering 200, the second film covering 300 adheres to the fibers 130 exposed on the mat second side 120 of the fibrous mat 100. In a preferred embodiment, the second film covering 300 encapsulates some of the fibers 130 on the mat second side 120. The second film protuberances 310 extend into the mat openings/passages 140 on the mat second side 120 of the fibrous mat. The second film perforations 320 are formed in the end of the second film protuberances 310 of the second film covering 300.

The extension of the first film protuberances and the second film protuberances 310 into the fibrous mat 100, inhibit the individual fibers 130 from escaping through the first film perforations 220 and the second film perforations 320, should those individual fibers become loose from the fibrous mat 100. Additionally, at various points in the fibrous mat 100, the first film perforations 220 may even join with the second film perforations 320 to form a passageway from the first film covering 200 to the second film covering 300.

The material of the first film covering 200 and the second film covering 300 is selected based upon the desired characteristics that the respective film covering will provide the composite structure 10. In one embodiment, the first film covering 200 and/or the second film covering 300 provides stiffness to the composite structure by using a thermoplastic material. Examples of thermoplastic materials that can be used in the present invention include high density polyethylene (HDPE), nylon, polyester, polypropolyene, polystyrene, polycarbonate, combinations thereof, or the like. Additionally, the material of the first film covering 200 and/or second film covering 300 can be filled to improve stiffness, with materials such as calcium carbonate, talc, clay, or other common filler materials.

In another embodiment, the first film covering 200 and/or the second film covering 300 is formed from an adhesive material to facilitate bonding of the composite structure 10 to other structures. Examples of adhesive materials that can be used in the present invention include copolymers of ionomers, ethylene acrylic acid (EAA), ethylene methyl acrylic acid (EMAA), ethylene vinyl acetate (EVA), ultra low density polyethylene (ULDPE), ethyl methyl acrylate (EMA), combinations thereof, or the like.

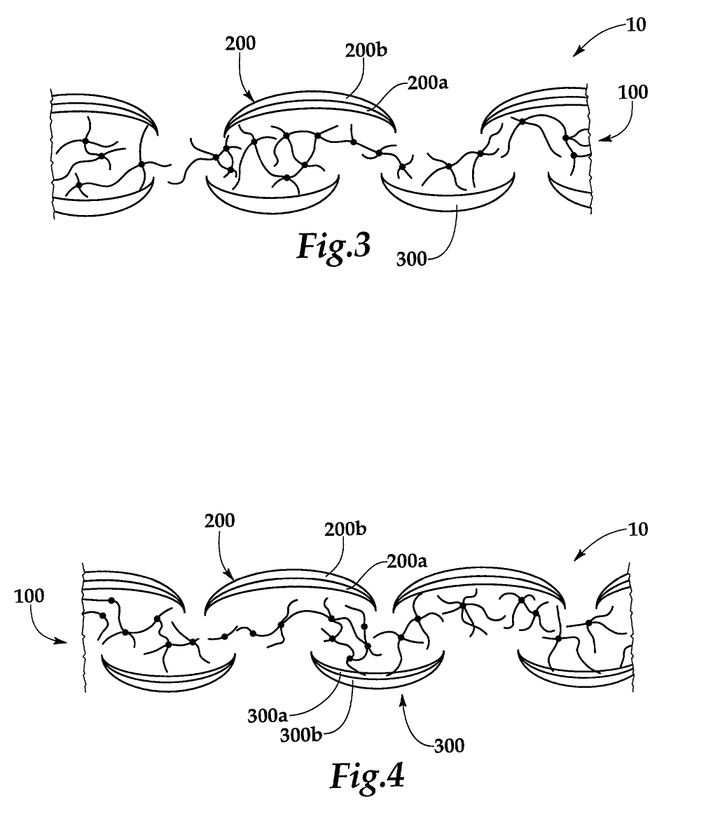

In yet another embodiment, the first film covering 200 and/or the second film covering 300 is a co-extrusion of two or more layers of various materials, as shown in FIGS. 3 and 4. For example, as shown in FIG. 3, the second film covering 200 can be a co-extrusion having a first film high density polyethylene layer 200a adjacent to the fibrous mat 100 to provide structural rigidity, and a first film adhesive material layer 200b on the opposing side to facilitate bonding of the composite structure 10. The co-extrusion of a material such as high density polyethylene between an adhesive layer and the fibrous mat 100 prevents the migration of the adhesive layer into the fiber material. In another example, as illustrated in FIG. 4, the second film covering 300 is also a co-extrusion having a second film high density polyethylene layer 300a adjacent to the fibrous mat 100 to provide structural rigidity, and a second film adhesive material layer 300b on the opposing side to facilitate bonding of the composite structure 10.

A part of the present invention is the unexpected additional stiffness of the composite structure 10. The completed composite structure has a stiffness greater than the stiffness of the fibrous mat 100, the first and second film coverings 200 and 300, or the expected stiffness of the combination of the fibrous mat 100, the first film 200, and the second film 300.

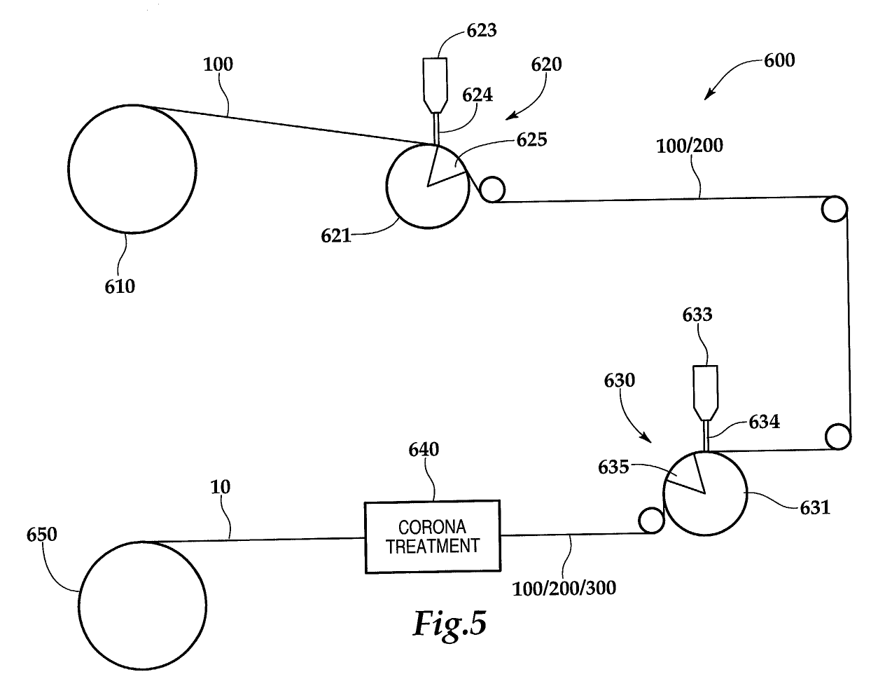

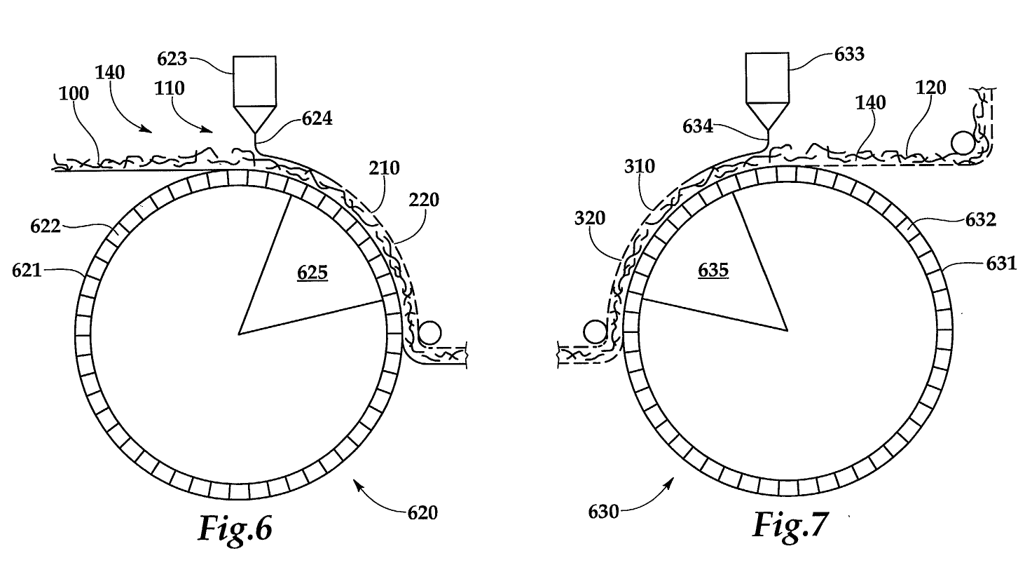

Referring now to FIGS. 5-7, there shown one embodiment of a process for forming the composite structure 10 from FIGS. 1-4, illustrated as the forming process 600. The forming process 600 generally includes a fibrous mat supply 610, a first film covering forming station 620, a second film covering forming station 630, a corona treating station 640, and a composite take up 650.

The fibrous mat 100 proceeds from the fibrous mat supply 610 to the first film covering forming station 620. At the first film covering forming station 620, the fibrous mat proceeds over a first vacuum screen 621. The first vacuum screen 621 includes a plurality of first vacuum screen apertures 622. A first extruder 623 extrudes a first film material 624 onto the fibrous mat 100 disposed on the first vacuum screen 621. A first vacuum source 625 behind the first vacuum screen 621 draws the first film materials 624 into the fibrous mat 100 forming the first film covering 200 with the first film protuberances 210 and the first film perforations 220 extending into the mat openings/passages 140. In one embodiment, the vacuum source 625 can provide a vacuum of about 20 inches of mercury or less, and preferably between about 10 to about 15 inches of mercury.

The fibrous mat 100 with the first film covering 200 thereon proceeds from the first film covering forming station 220 to the second film covering forming station 630. At the second film covering forming station 630, the fibrous mat 100 and the first film covering 200 are disposed on a second vacuum screen 631 with the first film covering 200 engaging the second vacuum screen 631. The second vacuum screen 631 includes a plurality of second vacuum screen apertures 632, such that at least a portion of the second vacuum screen apertures align with the first film perforations 220 in the first film covering 200. A second extruder 633 extrudes a second film material 634 onto the mat second side 120 of the fibrous mat 100. A second vacuum source 635 behind the second vacuum screen 621 draws the second film material 634 into engagement with the second mat side 120 of the fibrous mat 100 such that the second film material 634 encapsulates fibers 130 on the mat second side 120 of the fibrous mat, and extends into the mat openings/passages 140 on the mat second side 120 to form the second film protuberances 130 and the second film perforations 320 of the second film covering 300. In one embodiment, he vacuum source 635 can provide a vacuum of about 25 inches of mercury or less, preferably between about 5 to about 15 inches of mercury, and most preferably between about 8 to about 12 inches of mercury.

Although FIG. 5 is illustrated as a continuous single process, the present invention can be practice performing the application of the first film covering in a first process, and performing remaining steps in a second separate process. After the second film covering is formed on the fibrous mat 100, the composite structure 10 progresses to a corona treatment station 640, if corona treatment is desired on the final product. After final processing, the composite structure 10 is collected on the composite take up 650.

In addition to the previously mentioned criteria for selecting material of the fibrous mat 100, is the ability of the material of the fibrous mat 100 to be used in the forming process 600 of the composite structure 10. The fibrous mat 100 must be flexible enough to pass over the first and second vacuum screens 621 and 631, as well as the other equipment in the forming process 600. Also, the open area of the fibrous mat 100 the viscosity of the first and second film materials 624 and 634 must be sufficient that the first and second film materials 624 and 634 pull into the material of the fibrous mat 100 for aperturing. In one preferred embodiment, the first and second film materials 624 and 634 have a melt index of from about 5 to about 50, preferably from about 10 to about 25, and most preferably from about 15 to about 20.

The open area of the first vacuum screen 621 is selected to provide the highest probability of the first vacuum screen aperture 622 aligning with mat openings/passages 140 in the fibrous material 100, to facilitate the securing of the first film covering 200 on the fibrous mat 100. In one embodiment, the fibrous mat 100 had an open area of approximately 50%, the open area of the first vacuum screen 621 was from about 60% to about 70%, resulting in an open area of the combination of the fibrous mat 100 with the first film covering 200 of about 15%. The open area of the second vacuum screen 631 is selected to provide the highest probability of the second vacuum screen aperture 632 aligning with the first film perforations 222 in the first film covering. In one embodiment, the second vacuum screen 631 has an open area of from about 60% to about 70%, and was used on the combination of a fibrous mat 100 with a first film covering 200 having an open area of about 15%, which resulted in the combination of the fibrous mat 100 with the first film covering 200 and the second film covering 300 having an open area from about 1% to about 10%.

The above method was used to produce the following examples of the present invention:

### EXAMPLE 1

A JOHNS MANVILLE 8440 fiberglass mat is coated on each side with a high density polyethylene (HDPE) blend film having a weight per area of forty (40) grams per square meter. The HDPE blend includes seventy percent (70%), by weight, of EQUISTOR H6018 (HDPE) and thirty percent (30%), by weight, of DOW 2517 LDPE) and is about 1.5 mils. thick.

### EXAMPLE 2

A JOHNS MANVILLE 8450 fiberglass mat is coated on both sides by a laminate film. The laminate film has a first layer of HDPE blend disposed adjacent to the fiberglass mat, and a second layer of adhesive blend disposed on the side of the laminate opposite to the fiberglass mat. The first layer is a 0.25 mil. layer of an HDPE blend of seventy percent (70%), by weight, of EQUISTOR H6018 and thirty percent (30%), by weight, of DOW 2517. The second layer is a 1.25 mil. layer of an adhesive blend of seventy-five percent (75%), by weight, of DUPONT BYNEL 2022 (EMA copolymer) and twenty-five percent (25%), by weight, of DUPONT SURLYN 1855 (zinc ionomer).

### EXAMPLE 3

A JOHNS MANVILLE 8440 fiberglass mat is coated on a first side with a HDPE blend film, and on a second side with a adhesive blend film. The HDPE blend film is a 2.5 mil. film of a blend of seventy percent (70%), by weight, of EQUISTOR H6018 and thirty percent (30%), by weight, of DOW 2517. The adhesive blend film is a 1.0 mil. film of a blend of fifty-two and one-half percent (52.5%), by weight, of DUPONT 2022, seventeen and one-half percent (17.5%), by weight, of DUPONT 1855, and thirty percent (30%), by weight, of DOW 2517.

### EXAMPLE 4

A JOHNS MANVILLE 8440 fiberglass mat is coated on both sides with a 1.5 mil. polypropolyene blend film. In this embodiment, the polypropolyene blend is a blend of seventy percent (70%), by weight, of FINA 6573 (PP), twenty-two and one-half percent (22.5%), by weight, of DUPONT 2022, and seven and one-half percent (7.5%) of DUPONT 1855.

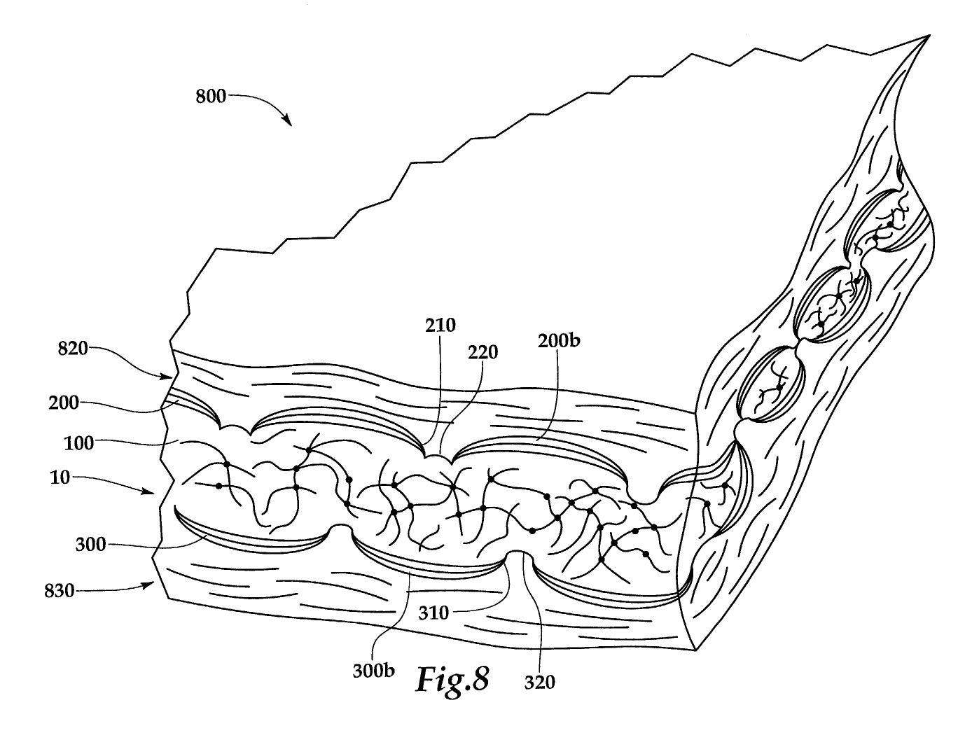

Referring now to FIG. 8, there is shown an embodiment of an invention utilizing the composite material in FIGS. 1-4, illustrated as the component structure 800. The component part 800 generally includes the composite structure 10, a structural foam 820, and a soft foam 830. The composite structure 10 is of the type having an adhesive layer 200b and 300b disposed outwardly from the fibrous mat 100, as shown in FIG. 4.

The component part 800 is formed by thermally activating the adhesive layers 200b and 300b on the composite structure 10, and affixing the structural foam 820 and the soft foam 830 to opposite sides of the composite structure 10. The component part 800 can be molded into a shape to accommodate the application of the component part 800 such as for a head liner in an automobile.

Use of the fibrous mat 10 with adhesive layers 200b and 300b, eliminates the need for an adhesive sheet between the fibrous mat and the structural foam 820 or the soft foam 830. Additionally, a part of the present invention is the discovery that the use of the composite structure 10 with the protuberances 210 and 310 and the perforations 220 and 320, provide unexpected additional acoustic attenuation properties to the component part 800.

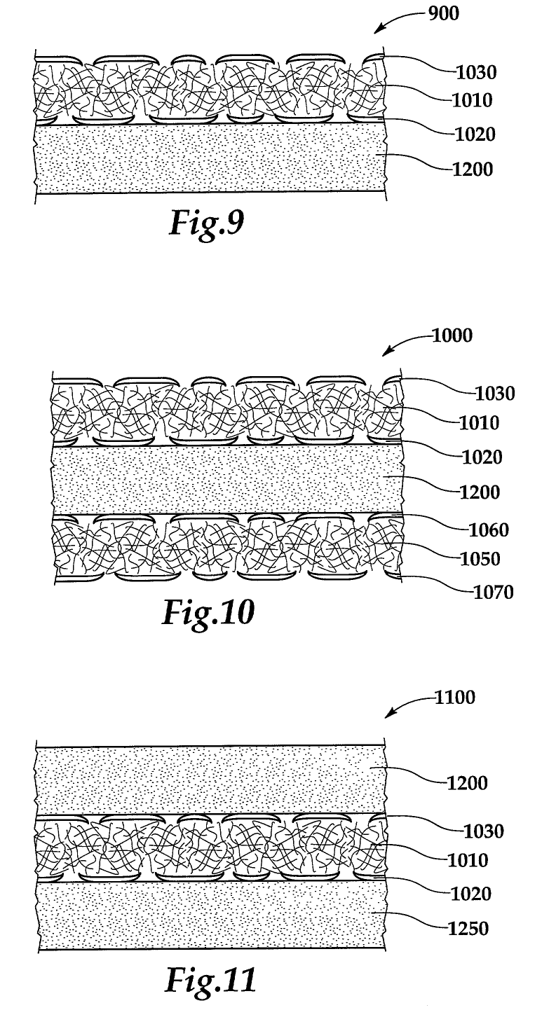

Referring now to FIG. 9, an alternative laminate material embodiment of the present invention is illustrated. As shown here, the laminate material 900 may have two or more components which are fused together to form an integral part. The first component is a vacuum formed coated fibrous mat 1010 as set forth and described hereinabove with reference to FIGS. 1-4. This mat 1010 is coated with a layer of polymer 1020, 1030 on both sides and vacuum formed to create apertures and passageways therethrough. The second component is a substrate 1200 which may be a polyurethane foam board, a fiber press board, a sheet of cardboard or the like. The laminate is produced by placing the substrate 1200 in contact with one of the polymer coated outer surfaces of the fibrous mat 1010 and then applying heat and pressure to soften the polymer coating 1020. The polymer coating 1020 should be softened or melted sufficiently to fuse the substrate 1200 and the fibrous mat 1010 to each other upon cooling. As will be discussed in greater detail hereinbelow, the application of heat and pressure may be simultaneous as with a commercial laminating machine or it is possible to first heat the coated fibrous mat 1010 and then adhere it to the substrate 1200 under pressure before the polymer coating 1020 has cooled.

This type of laminate composite material is relatively inexpensive to produce and may serve a number of useful functions. These structures offer the acoustical attenuation properties of the apertured fibrous mat in combination with the material bulk and added rigidity of the substrate. Additionally, a somewhat rigid substrate such as a polyurethane foam board will gain additional strength and stiffness by bonding it to the fibrous mat. The laminated foam board would also be highly resistive to denting and cutting on its coated surfaces. This is mechanically similar to coating the surface of the substrate with chopped glass fiber, adding a resin, and curing the product to form a fiberglass composite material. However, the chopped glass and resin technique requires a great deal of labor and yields a final product which may have an uneven distribution of the chopped glass across the surface of the substrate. The prior art composite material also has a solid skin on its outer surfaces which do not attenuate sound. To improve sound absorption, the manufacturer must then needle punch the final part which requires additional labor and may result in a loss of stiffness or breakage. In contrast to the smooth surface and additional processing required for chopped glass and resin, the heating step required for producing the laminate of the present invention actually causes the polymer coating to contract or draw up into itself. This has the added benefit of causing a significant increase in the open area of the polymer coating, thus making it even easier for sound to pass through the coated mat layer and be absorbed by the foam layer. By way of example only, it is the inventors' belief that coated mats typically having a surface open area of about 0.5% to about 5.0% will, during processing into a laminate, open up to about 5.0% to 75% open area. Of course, if a smooth surface were desired, coatings such as paper, fabric, polymer film, or metal foil can be added to the exterior of the laminate to provide the laminate with a moisture barrier and/or merely a decorative appearance.

Many different applications of these laminate structures are possible. For example, it is possible to create laminates in accordance with the present invention using a variety of structural foams for use as thermal or acoustical insulation in automotive and other applications. It is possible to make fiberboard laminates to create ceiling tiles which are less prone to breakage. Additionally, cardboard laminates may be used to make inexpensive housings or surrounds for a variety of products.

Referring now to FIGS. 10 and 11, two additional embodiments of the laminate material are shown. FIG. 10 illustrates a laminate structure having a foam board substrate 1200 at its core and a vacuum formed coated fibrous mat 1010, 1050 adhered to each of the external surfaces. Each fibrous mat 1010, 1050 has an apertured polymer coating 1020, 1030, 1060, 1070 on the upper and lower surfaces which may be heated to fuse the mats 1010, 1050 and the substrate 1200 together. This particular sandwich structure offers a great deal of stiffness and also features sound attenuation, dent resistance and puncture resistance on both sides of the finished part. This particular type of laminate material makes use of the mechanical principal known as the I-beam effect. By contrast, as shown in FIG. 11, it is possible to use a coated fibrous mat 1010 as a core disposed between to layers of foam board substrate 1200, 1250. This structure lacks sound attenuation and dent resistance, but offers a stiffened foam board structure of remarkable strength.

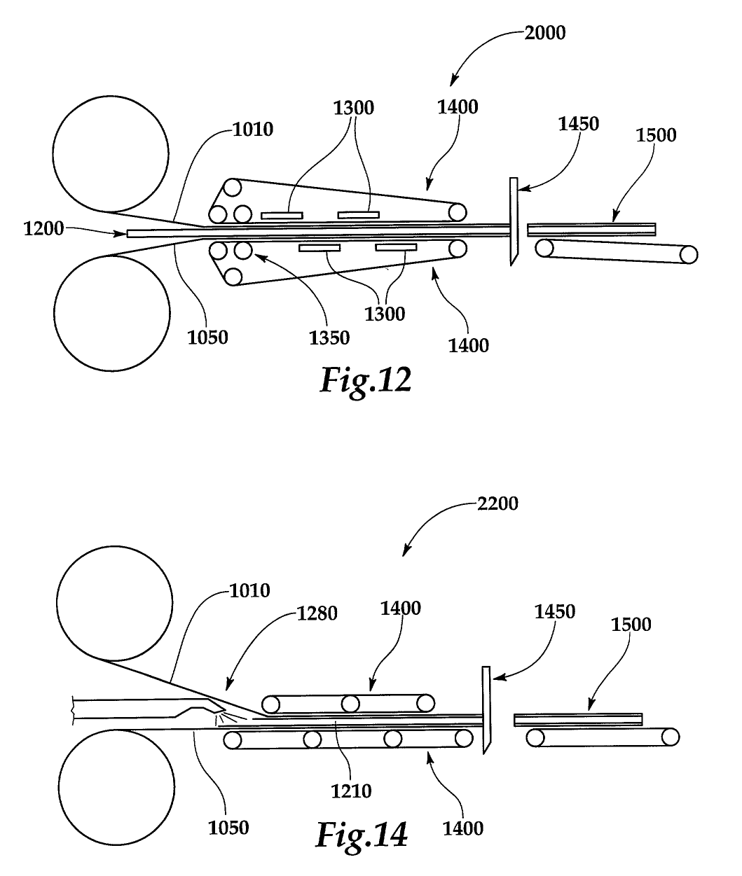

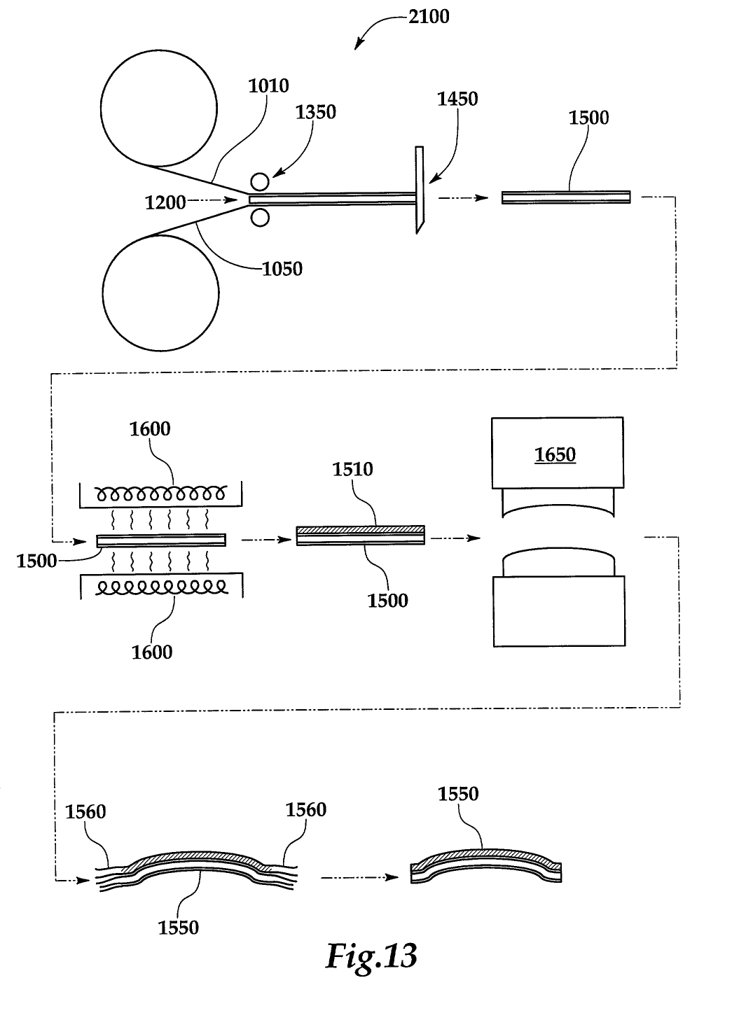

Referring now to FIGS. 12 and 13, two differing methods for producing a laminate in accordance with the present invention are shown. These processes illustrate a laminate structure according to FIG. 10 having a foam board core disposed between two vacuum formed coated fibrous mats. However, it is to be understood that these methods may be used to produce laminates with two, three, four or more layers, limited only by the ability of the equipment to accommodate thicker laminates and still provide sufficient heat and pressure to ensure good bonding at the interfaces. FIG. 12 shows a process 2000 for producing a laminate material 1500 using a commercial high production, continuous duty fusing system as part of a continuous production line. One such fusing system is the 6800 Series available from Astechnologies, Inc. of Atlanta, Ga. which features a wide width, heavy duty construction and six individually controlled heating zones.

Referring still to FIG. 12, a foam board core 1200, such as BURKHARDT CPRB (density=2 lb/ft³), is directed to a nip arrangement 1350 with a feed roll of coated mat material located above and below. The coated mat material 1010, 1050 is rolled out onto the upper and lower external surface of the foam board core 1200. The nip 1350 allows the operator to control the pressure applied to the multiple layer structure during lamination. In a commercial lamination apparatus, the coated mat/foam core/coated mat sandwich is advanced by continuous conveyors 1400 which contact the upper and lower surfaces. A number of heaters 1300 are disposed inside these conveyors, adjacent to the belts which are in contact with the sandwich. These heaters 1300 will bring the coated mat material 1010, 1050 and the surface of the foam core 1200 to a temperature of about 140 to about 240° C. The laminate or blank 1500 is then cooled to a temperature of less than about 125° C. By applying heat and pressure, the polymer coating on the coated mat is mechanically fused to the foam board core. In short, the polymer coating and the foam board core will be held together by polymer chain entanglement at the interface.

With reference now to FIG. 13, an alternative laminate forming method which heats the sandwich and applies pressure in separate step is shown. In this process 2100, a foam board core 1200 is again directed to a nip arrangement 1350 with coated mat material 1010, 1050 placed on the upper and lower external surfaces. The sandwich is then trimmed with a shear cutter 1450 to form a blank 1500 of a particular size. The blank 1500 is then warmed by heating coils 1600 until the polymer coatings melt and optional surface coverings, such as fabric 1510 and the like, may be applied. the heated blank 1500 is then placed in a forming press 1650 where it is compressed in a mold. The semi-finished laminate part will be completely fused and will have its finished shape. Further trimming steps may be performed to create a finished part 1550 with exact physical dimensions and to remove excess material 1560 from the perimeter of the part. This method is particularly well suited to the production of automotive headliners which would require subsequent cutting, thermoforming, and trimming a steps if the laminate is produced by commercial fusing machine method illustrated in FIG. 12.

Referring now to FIG. 14, another embodiment of the manufacturing technique in accordance with the present invention is shown. In the methods discussed hereinabove, coated fibrous mats are essentially laid-up on a substrate, such as a polyurethane foam board, passed through a lamination step and then trimmed to size. Although the foam board sheets may be quite large and several parts may be cut from a single sheet, it is further contemplated that the laminate of the present invention may also be produced in a more continuous fashion. This may be accomplished by rolling out two layers of coated mat and forming a polymer foam layer in situ between them. This type of process is further discussed on pages 9-50 through 9-54 of a paper entitled “Polyurethane Foams Formulation and Manufacture” by Robert L. McBrayer and Donald C. Wysocki (rev. February 2000, Technomic Publishing Co., Lancaster, Pa.), this portion of which is incorporated herein by reference.

In this process 2200, polyurethane foam chemicals are injected under pressure from a nozzle 1280 into a gap between two sheets of facing material 1010, 1050, such as a coated fibrous mat in accordance with the present invention, and allowed to polymerize and foam. The foam line is designed and controlled so as to produce a finished laminate sheet 1500 with the physical dimensions and mechanical properties desired. The coated fibrous mat may be used as one or both of the facing sheets, and it is believed that the resulting laminate material will exhibit the same structural and acoustic properties noted earlier. By way of example only, other possible facing materials may include metal foil, paper, cardboard, and woven or non-woven textiles.

An obvious problem with applying liquid chemicals to produce a foam layer on an apertured facing material, like a coated fibrous mat, is that the chemicals will tend to seep through the pores in the facing material and onto the production line itself. This problem may be addressed in at least two ways. One approach is to carefully control the vacuum pressure during production of the coated fibrous mat to obtain a surface on one side of the mat which adheres to the fibers but is not apertured. Another approach is to produce the coated fibrous mat with apertures and to subsequently coat one side of the mat with an additional polymer coating layer of about 0.1 mils (0.0001 inches) to about 1.0 mils (0.001 inches) in thickness using a vacuum coating technique at vacuum levels of about 0.0 to about 2.0 inches of mercury (Hg). This additional coating will effectively fill the apertures and prevent seepage of the foam chemicals. If this coating is applied thinly, it may be possible to reopen the apertures in the coated mat facing layer, after the foam core has set, by applying heat to the coating. This is very similar to the opening up or increase in open area which occurs during lamination. Heating the coating to above its melting point causes the polymer to flow, shrink, contract and open the apertures back up. This heating step may actually occur in the foam curing oven or, alternatively, during post curing.

The following example will set forth one possible method of producing a vacuum formed coated fibrous mat material which has been provided with an additional coating to prevent seepage of the foam chemicals. This mat material should be particularly well suited to the production of in situ foam laminates:

### EXAMPLE 5

A 60 gram per square meter (gsm) fiberglass mat, namely NICOFIBERS SURMAT 200, is vacuum coated with a 3 mil coating of a blend composed of 70% of an 18 melt flow HDPE and 30% of EMA, (EQUISTAR H6018 and DUPONT BYNEL 2022, respectively). The polymer is pellet blended and fed to an extruder for melting and mixing and is passed through an extrusion die to form a melt curtain. The temperature of the polymer melt is between 220 and 290° C. (428 and 554° F.) and preferably is between 245 and 270° C. (473 and 518° F.). The fibrous mat is unwound from a stock roll and is passed over a vacuum drum at the first coating station and from there to a rewind unit or a second coating station.

At the first coating station the polymer melt is disposed onto the fibrous mat which is pulled through the coating station. As the mat passes over the vacuum drum a vacuum of up to 20 inches mercury, and preferably 10 to 15 inches mercury vacuum, is pulled on the drum. This vacuum is applied to the fibrous mat and to the film pulling passages from the surface down into the fibrous mat. After cooling the coated fibrous mat can be rewound or transferred to a second coating station.

At the second coating station, a polymer coating DOW 2517, a 25 melt flow LDPE, is disposed onto the previously coated layer of HDPE and BYNEL. This second layer is extruded at between 220 and 275° C. (428 and 527° F.) and preferably at between 230 and 260° C. (446 and 500° F.). A vacuum is applied at between 0.1 and 3 inches of mercury and preferably between 0.2 inches and 2 inches of mercury. The second polymer coating layer is drawn into and substantially fills the apertures of the first coating layer to prevent seepage of foam chemicals.

Although preferred embodiments of the invention have been described in the examples and foregoing description, it will be understood that the invention is not limited to the embodiments disclosed, but is capable of numerous rearrangements and modifications of parts and elements without departing from the spirit of the invention, as defined in the following claims. Therefore, the spirit and the scope of the appended claims should not be limited to the description of the preferred embodiments contained herein.

What is claimed is:

1. A composite structure comprising:
a vacuum formed coated fibrous mat comprising:
a fibrous mat having a mat first side and a mat second side, said fibrous mat being formed from a plurality of fibers such that a plurality of passages are formed therein;
a first film covering disposed on the mat first side of said fibrous mat, said first film covering including a plurality of first film protrusions with first film apertures, the plurality of first film protrusions extending into the plurality of passages in said fibrous mat; and
a second film covering disposed on the mat second side of said fibrous mat, said second film covering including a plurality of second film protrusions with second film apertures, the plurality of second film protrusions extending into the plurality of passages in said fibrous mat;
a substrate disposed adjacent to said first film covering; and
wherein said vacuum formed coated fibrous mat and said substrate are fused together to form a laminate under applied heat and pressure.

2. The composite structure according to claim 1, wherein said substrate is a polyurethane foam board.

3. The composite structure according to claim 1, wherein said substrate is a fiber press board.

4. The composite structure according to claim 1, wherein said first film covering is a heat-activated adhesive film.

5. The composite structure according to claim 1, further comprising a second substrate disposed adjacent to said second film covering; and
wherein said vacuum formed coated fibrous mat and said second substrate are fused together to form a laminate under applied heat and pressure.

6. The composite structure according to claim 5, wherein said second substrate is a polyurethane foam board.

7. The composite structure according to claim 5, wherein said second substrate is a fiber press board.

8. The composite structure according to claim 6, wherein said second film covering is a heat-activated adhesive film.

9. A composite structure comprising:
a first and a second vacuum formed coated fibrous mat, wherein each vacuum formed coated fibrous mat further comprise:
a fibrous mat having a mat first side and a mat second side, said fibrous mat being formed from a plurality of fibers such that a plurality of passages are formed therein;
a first film covering disposed on the mat first side of said fibrous mat, said first film covering including a plurality of first film protrusions with first film apertures, the plurality of first film protrusions extending into the plurality of passages in said fibrous mat; and
a second film covering disposed on the mat second side of said fibrous mat, said second film covering including a plurality of second film protrusions with second film apertures, the plurality of second film protrusions extending into the plurality of passages in said fibrous mat;
a substrate disposed between and oppositely adjacent to said first and said second vacuum formed coated fibrous mat; and
wherein said substrate and said first and said second vacuum formed coated fibrous mat are fused together to form a laminate under applied heat and pressure.

10. The composite structure according to claim 9, wherein said substrate is a polyurethane foam board.

11. The composite structure according to claim 9, wherein said substrate is a fiber press board.
